(19) United States
(12) Patent Application Publication
(10) Pub. No.: US 2004/0120757 A1
(43) Pub. Date: Jun. 24, 2004

(54) Flexible drapery rod

(76) Inventor: Ian Ellbogen, Montreal (CA)

Correspondence Address: Vincent L. Ramik, DILLER, RAMIK & WIGHT, Suite 101, 7345 McWhorter Place, Annandale, VA, 22003, US

(21) Appl. No.: 10/327,008

(22) Filed: Dec. 24, 2002

(51) Int. Cl. F16B 1/00

(52) U.S. Cl. 403/223

(57) ABSTRACT

A flexible rod portion for suspending a drape therefrom. The flexible rod portion has a flexible tubular body comprising at least two contiguously intertwined serpentine members, helically interlocked and free to move relative to one another along a length of the flexible tubular body. The flexible tubular body can be variably deformed and is capable of being positioned into a set curved configuration.

### TECHNICAL FIELD

The present invention relates generally to a rod for supporting drapes, curtains and the like. More particularly, the present invention relates to a flexible portion for such rods.

### BACKGROUND OF THE INVENTION

Bay and corner windows have long since posed problems for curtain rod installation. It has been known to employ individual curtain rods for each pane of a bay window, for example, and bracket supporting each individual rod. Individual rods supported by shared brackets that support adjacent ends of adjacent rods have also been used. These arrangements have generally made way for installations having a single continuous rod that extends around the entire width of the bay or corner window. However, this implies that the rod used to support the curtain or drapery has corner sections that are shaped to correspond with the window as required. In some instances, pre-formed corners having the necessary curvatures have been used. Jointed or articulated rods hinged at adjacent ends are similarly known.

Having pre-formed rigid rod corners is effective, however such rods can be impractical due to difficulties in adapting the pre-shaped rods to all installations. Standard sized corners may not easily fit within bay windows having an uncommon shape, for example. If a standard curved rod is required, it would be necessary to pre-shape the rod using a forming jig or another tool. If, however, a special configuration is required, it can be necessary to take precise measurements of the window, and subsequently have the rod preformed at the factory. These processes are time consuming, expensive and not very practical. If the preformed rod does not exactly fit the particular installation, adjustments to correct the curvature are difficult. Additionally, once a preformed rod is created having a specific curvature for a particular installation, it is often difficult to re-shape the rod for another application. As a result, drapery rod corners that can be adjusted as required to suit different shaped windows have evolved.

U.S. Pat. No. 2,890,799 issued to Rosenbaum on Jun. 16, 1959, for example, teaches a flexible traverse rod for drapery or curtain installations, that can be curved to any predetermined configuration. The flexible rod comprises a plurality of spaced, laterally-extending slots, which enable the rod to be curved in any desired direction within a single plane. The flexible rod can be formed such that is has either a gradual curve, or a 90 degree angled corner.

U.S. Pat. No. 5,263,594 issued to Bianchi on Nov. 23, 1993, also discloses a flexible curtain rod for supporting a curtain around an intermediate corner. The flexible rod corner can be bent into a desired orientation by having a plurality of variously shaped partial notched slots. These slots enable the flexible corner juncture element to be bent into any desired angle. The corner element comprises two rigid tubular continuous elements that can be bent together with the body and are embedded therein, which help to retain the bent configuration given the flexible corner element.

Both of these references include slots or notches formed through the curtain rod, such that the rod can be bent into a curved shape as required. However, these designs only permit curvature of the rod in a single plane. Additionally, as each slot only provides a small degree of rod curvature before inside edges of the slots abut one another thereby closing the slot, many slots are required to achieve the necessary bend in the rod. The high number of slots tends to weaken the overall rod strength, and generally limit the radius of curvature possible. A flexible drapery rod corner that permits a tight radius of curvature is accordingly difficult to achieve with these designs.

### SUMMARY OF THE INVENTION

It is an object of the present invention to provide an improved flexible rod from which to suspend curtains, drapes and the like.

It is another object of the present invention to provide a flexible drapery rod capable of being easily configured to fit any installation requiring a curved rod portion.

It is another object of the present invention to provide a flexible drapery rod capable of being curved in many directions.

It is another object of the present invention to provide a flexible drapery rod permitting a wide range of curvatures, including ninety degree corners.

It is a further object of the present invention to provide a flexible drapery rod corner capable of being reshaped a plurality of times without negatively affecting the strength of the rod.

Therefore, in accordance with the present invention, there is provided a flexible rod portion for suspending a drape therefrom, having a flexible tubular body comprising at least two contiguously intertwined serpentine members, helically interlocked and free to move relative to one another along a length of the flexible tubular body, such that the flexible tubular body can be variably deformed and is capable of being positioned into a set curved configuration.

There is also provided, in accordance with the present invention, a method for installing a rod assembly adapted for suspending a drape around at least one corner, the method comprising: providing at least two rigid rod portions; providing at least one flexible rod portion having a flexible tubular body that can be variably deformed to position the flexible tubular body into a set curved configuration and that is repositionable any number of times into different set curved configurations; removably fastening the flexible rod portion between adjacent ends of the rigid rod portions, such that the flexible rod portion and the rigid rod portions form a composite rod section of the rod assembly; deforming the flexible tubular body of the flexible rod portion in situ, to create a set curved configuration thereof forming an angle substantially corresponding to that of the corner; and fixing the rigid rod portions to a surrounding structural member, such that the flexible rod portion having the set curved configuration extends the composite rod portion substantially continuously around the corner.

### BRIEF DESCRIPTION OF THE DRAWINGS

Further features and advantages of the present invention will become apparent from the following detailed description, taken in combination with the appended drawings, in which:

FIG. 1 is an elevation view of the flexible drapery rod portion according to the present invention.

FIG. 2a is a top elevation view of the flexible drapery rod portion of FIG. 1, bent having a gradual curve.

FIG. 2b is a top elevation view of the flexible drapery rod portion of FIG. 1, bent having a ninety degree curved.

FIG. 2c is a top elevation view of the flexible drapery rod portion of FIG. 1, formed into a U-shape.

FIG. 3 is a top elevation view of a bay window having a drapery rod assembly comprising flexible drapery rod corner portions of FIG. 1.

FIG. 4 is a top elevation view of a corner window installation having a drapery rod assembly comprising the flexible drapery rod corner portions of FIG. 1.

### DETAILED DESCRIPTION OF THE PREFERRED EMBODIMENT

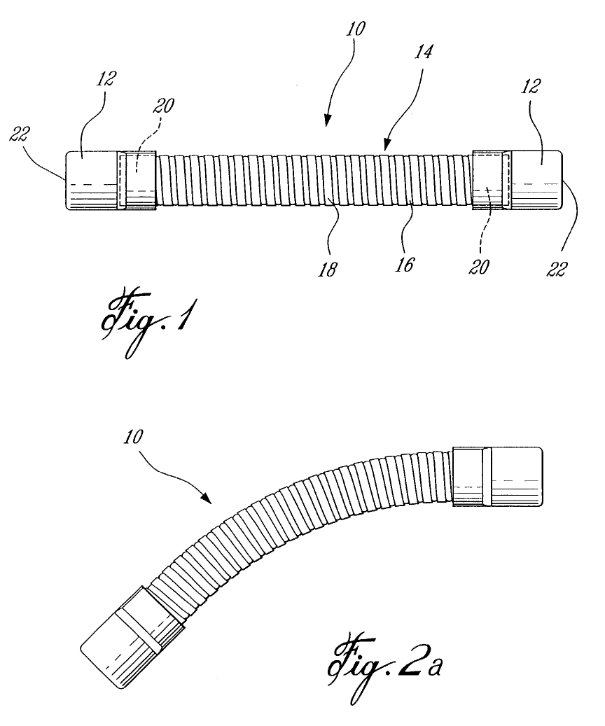

Referring to FIG. 1, the flexible drapery rod portion 10 comprises principally a central flexible tube body 14 capped by rod attachment members 12 at either end thereof. The central flexible tube body 14 is preferably an integrally formed tube member having an inner wire coil 16 and an outer shell 18. Both the inner wire coil 16 and the outer shell 18 are generally helically shaped and are intertwined, and contiguously interlocked without being fixed together along the length of the elongated body. The wire coil 16 and the outer shell 18 are serpentine members, being bodies generated by a closed loop or polygon orbiting about a line while undergoing translation along the line. The wire coil 16 preferably comprises a closed loop shape that is a circle, therefore providing a structure resembling a helical coil spring. The outer shell 18 preferably has a substantially rectangular cross-section, with the two longer sides being substantially longitudinally directed. The wire coil 16 and the outer shell 18 are preferably fixed together at either end 20 of the central flexible tube body 14, within the rod engaging end members 12. These rod attachment members are generally hollow cylindrical elements sized to fit over the ends 20 of the central flexible tube 14, and fastened thereto by known method which can include, but are not limited to, crimping, welding, bonding, and being pined. The outer ends 22 of the rod attachment members 12 are preferably open, and comprise an inner thread such that a threaded rod element can be engaged therein to fasten the rod attachment member 12 to an adjacent end of a standard rigid curtain rod.

The inverse, wherein the threaded rod element extends from the rod attachment members 12 and engages tapped holes in the ends of the rigid curtain rod sections, is similarly equivalent. Other equivalent fastening methods can also be used to engage the flexible rod portion 10 to the abutting rigid curtain rod sections. The flexible rod portion 10 preferably has a circular cross-sectional area, and preferably has a diameter substantially equivalent to those of the adjacent rigid curtain rod sections to which the flexible rod portion is abutted. This provides a generally continuous, composite curtain rod assembly that can be easily formed to correspond with any corner or angled window installation.

The flexible tube body 14 is preferably of the type used as “goose-neck”. This flexible tubing is commonly used in applications such as flexible desk lamp stems, and the like. The “goose-neck” structure generally comprises two intertwined helical elements, for example the inner wire coil 16 and the outer shell 18, integrally forming the flexible tubing. The inner wire coil 16 and the outer shell 18 helically intertwined without being fixed together along the length of the flexible tube body 14. The “goose-neck” tubing is capable of being selectively deformed into almost any desired position, and is capable of retaining the given position while nevertheless being subsequently repositionable into a different position, which can also be maintained until such time as the structure is repositioned. However, one skilled in the art will appreciate that another similarly flexible tubular material having similar properties can alternately be employed in the flexible rod portion 10 of the present invention. The flexible rod portion 10 is preferably used in conjunction with standard rigid, circular drapery rods generally used in conjunction with a plurality of rings having an inner diameter which is larger than the outer diameter of the drapery rod and which are adapted for supporting the drape or curtain therefrom, and which are slidingly suspended from the drapery rod.

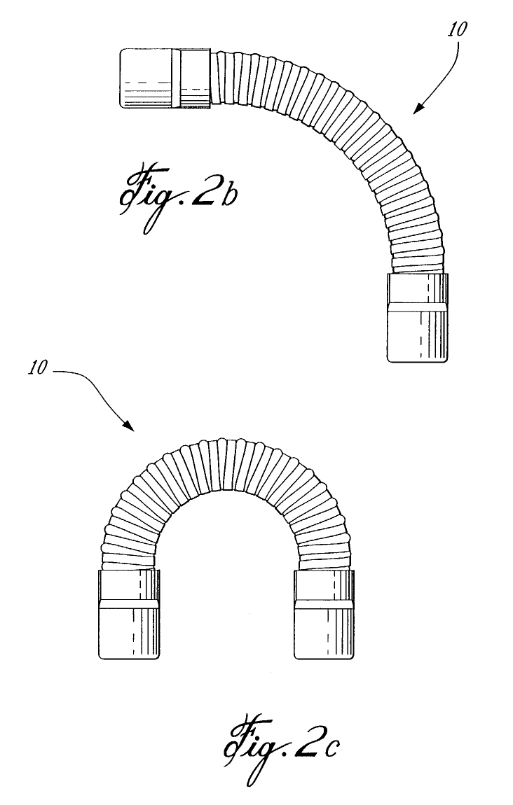

The flexible drapery rod portion 10 is preferably used as a corner portion, engaged between two sections 34,35,44 of standard rigid curtain rod. The properties of the “goose-neck” which makes up the central flexible tube body 14 of the flexible rod portion 10, permit the flexible rod portion 10 to be given and retain, substantially any shape. As such, the flexible rod portion 10 can be bent, or curved, such that it comprises a curved configuration between the abutted rigid rod sections. Although simple curves having an angle of 90 degrees or an angle of between about 90 and 180 degrees are most commonly used, almost any alternately angled curved configuration is equally possible. FIG. 2a shows the flexible drapery rod portion 10 having been given a gradual obtuse curve. FIG. 2b shows the flexible rod portion 10 formed into a right angled corner, and FIG. 2c alternately depicts a flexible rod portion having a fully U-shaped curve, defining an angle equal to or just greater than 0 degrees. The flexible drapery rod portion 10 is therefore sufficiently flexible to permit being formed into substantially any shaped curve, while being rigid enough to retain a shape given it and be able to support rings or similar attachments from which a drape or curtain is suspended. The flexible drapery rod portion 10 additionally permits being selectively re-formed into another shape many times, without causing any weakening or cyclic fatigue of the flexible rod portion. Multiple, or compound, curves are additionally possible using the flexible rod portion 10, such that a curved shape comprising more than one radius of curvature in either a common plane, or defined in several different planes.

When the term drapery rod is used herein to describe the present invention and applications thereof, one skilled in the art will appreciate that this will include curtain rods, and any other rod or track from which drapes, curtains, and the like can be suspended. Similarly, when the term drape is used herein, it is intended to include all substantially flexible structures that can be suspended from a rod, and can be used either as window coverings such as curtains, or alternately as room dividers, visual screens, protective curtains, and the like. While the flexible rod portion 10 is described herein with preference to use as a support for window coverings, one skilled in the art will understand that the use of the present invention for any of the above alternate applications is similarly possible.

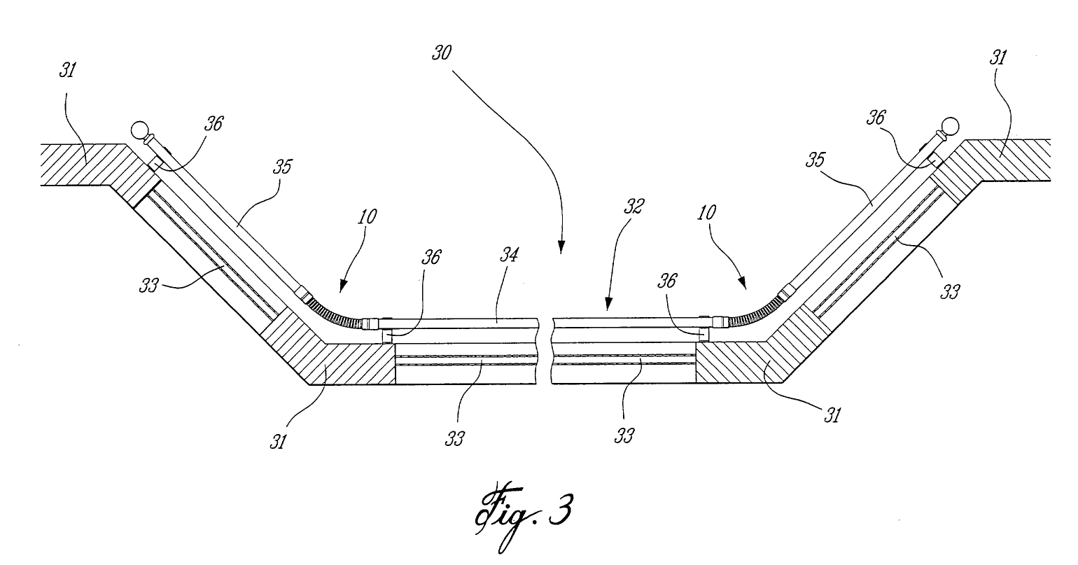

Referring to FIG. 3, the bay window installation 30 generally comprises a bay window drapery rod assembly 32 comprising principally several sections of rigid drapery rod, linked with flexible drapery rod portions 10 therebetween. The drapery rod assembly 32 depicted being installed within a bay window having three sides, however the present invention can be similarly employed in any bay window having more or fewer window panes. Additionally, the assembly 32 can accommodate any shaped bay window, as the flexible corner portions 10 can be easily curved to correspond to the particular angles between adjacent panes of the bay window. The window panes 33 are disposed within wall sections 31. Installation of such an assembly is easy, once the rigid rod sections are of the correct length. With the rod support brackets 36 fixed in place, the flexible rod portions 10 can be removably fastened to both ends of the center rigid rod section 34. The two side rigid rod sections 35 can the be similarly fastened to the opposite ends of the flexible rod portions 10, creating an selectively articulate three-link drapery rod assembly 32. The center rigid rod can then be engaged to the support brackets 36, overtop the central window pane 33. The two flexible rod corners 10 permit the in situ adjustment of the corner angle as required by the specific geometries of the particular installation. The side rigid rod sections 35 can then be engaged to similar support brackets 36. Even once installed in place above the windows, the flexible corner can be curved and re-curved as required, permitting unlimited selective adjustment of the assembly, without having to remove the drapery rod assembly 32 from the support brackets and without having to remove any elements to modify their shape.

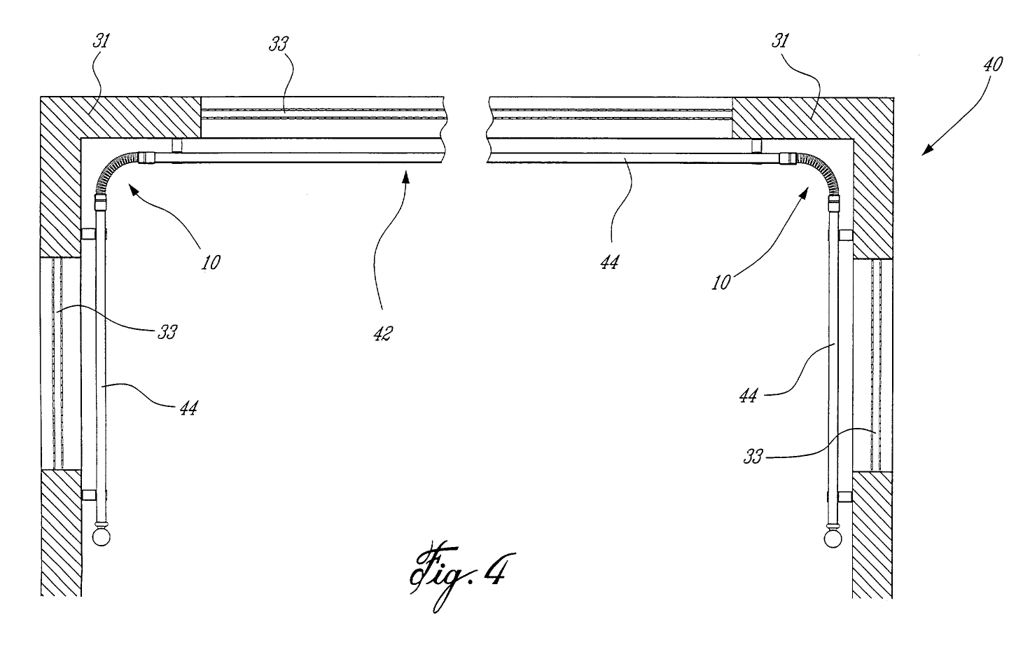

Referring now to another possible application of the present invention as depicted in FIG. 4, wherein the flexible drapery rod portion 10 of the present invention is used to create a corner window drapery rod assembly 42, installed within a right-angled corner of a room. The corner window installation 40 has window panes 33, disposed at ninety degrees from one anther on abutting walls 31 of a right angled corner. The rigid rod sections 44 are inter-engaged by the flexible drapery rod corner portions 10 which are given a right-angled shape, enabling a ninety degree drapery rod corner to be possible. As described above, once installed in place above the windows, the flexible corners 10 can be adjusted as required in situ. Although the installation shown comprises a right-angled corner window, the corner drapery rod assembly 42, having any number of rigid rod sections 44 and flexible corner portions 10, can equivalently be used in other interior corners having any angle. Although preferably adapted to provide corners between 90 and 180 degrees inclusive, the flexible rod portions 10 can nevertheless be used for acute angles less than 90 degrees. These can occur in odd shaped rooms, such as substantially triangular shaped corners having an narrow intersection angle between abutting walls.

For aesthetic reasons, the flexible drapery rod portion 10 is preferably painted or otherwise coated, such that it is has a colour substantially similar to that of the rigid drapery rod sections being used for a particular application. For example, the entire flexible drapery rod portion 10 can be plated, with brass or bronze for example, such that when engaged between similarly finished rigid drapery rod sections, a visually uniform composite rod is provided.

The embodiments of the invention described above are intended to be exemplary only. The scope of the invention is therefore intended to be limited solely by the scope of the appended claims.

I claim:

1. A flexible rod portion for suspending a drape therefrom, having a flexible tubular body comprising at least two contiguously intertwined serpentine members, helically interlocked and free to move relative to one another along a length of the flexible tubular body, such that the flexible tubular body can be variably deformed and is capable of being positioned into a set curved configuration.

2. The flexible rod portion as defined in claim 1, wherein the flexible tubular body comprises goose neck tubing.

3. The flexible rod portion as defined in claim 1, wherein the flexible tubular body retains the set curved configuration until being repositioned.

4. The flexible rod portion as defined in claim 3, wherein the flexible tubular body is repositionable substantially any number of times into different set curved configurations without causing plastic deformation of the contiguously intertwined serpentine members.

5. The flexible rod portion as defined in claim 1, wherein the set curved configuration is disposed in at least one plane defined by a longitudinal axis of the flexible tubular body.

6. The flexible rod portion as defined in claim 5, wherein the contiguously intertwined serpentine members of the flexible tubular body are displaceable relative to one another to permit positioning the flexible rod portion into a compound curve.

7. The flexible rod portion as defined in claim 6, wherein the compound curve is disposed in more than one plane, each defined by a longitudinal axis of the flexible tubular body.

8. The flexible rod portion as defined in claim 1, wherein the set curved configuration comprises a curve having an angle between 0 and about 180 degrees.

9. The flexible rod portion as defined in claim 1, wherein the curve comprises a radius of curvature as tight as about 0.25 times the length of the flexible tubular body.

10. The flexible rod portion as defined in claim 1, wherein flexible rod portion is engageable between adjacent ends of rigid rods to produce a substantially continuous composite rod assembly, having a variably deformable flexible corner portion.

11. The flexible rod portion as defined in claim 10, wherein the composite rod assembly is adapted for mounting in a bay window.

12. The flexible rod portion as defined in claim 10, wherein the composite rod assembly is adapted for mounting in a corner.

13. The flexible rod portion as defined in claim 10, wherein the flexible rod portion has a diameter substantially equal to a diameter of at least one of the rigid rods engaged thereto.

14. The flexible rod portion as defined in claim 10, wherein the flexible rod portion is removably fastenable to the rigid rods by a threaded engagement.

15. The flexible rod portion as defined in claim 1, wherein the flexible rod portion comprises a decorative coating thereon.

16. The flexible rod portion as defined in claim 15, wherein the coating comprises one of paint and metallic plating.

17. A method for installing a rod assembly adapted for suspending a drape around at least one corner, the method comprising:
providing at least two rigid rod portions;
providing at least one flexible rod portion having a flexible tubular body that can be variably deformed to position the flexible tubular body into a set curved configuration and that is repositionable any number of times into different set curved configurations;
removably fastening the flexible rod portion between adjacent ends of the rigid rod portions, such that the flexible rod portion and the rigid rod portions form a composite rod section of the rod assembly;
deforming the flexible tubular body of the flexible rod portion in situ, to create a set curved configuration thereof forming an angle substantially corresponding to that of the corner; and
fixing the rigid rod portions to a surrounding structural member, such that the flexible rod portion having the set curved configuration extends the composite rod portion substantially continuously around the corner.

18. The method for installing a rod assembly as defined in claim 17, wherein the flexible tubular body of the flexible rod portion is manually deformable without the aid of any tools.

19. The method for installing a rod assembly as defined in claim 17, further comprising installing the rod assembly in a bay window.

20. The method for installing a rod assembly as defined in claim 17, further comprising installing the rod assembly in a corner window.

21. The method for installing a rod assembly as defined in claim 17, wherein once deformed into the set curved configuration and fixed to the surrounding structural member, the set curved configuration of the flexible tubular body can be adjusted in situ.

22. The method for installing a rod assembly as defined in claim 17, wherein the flexible tubular body retains the set curved configuration until being repositioned.

23. The method for installing a rod assembly as defined in claim 22, further comprising repositioning the flexible tubular body into a different set curved configuration to correspond to a different corner installation, without causing substantial plastic deformation of the flexible tubular body.

24. The method for installing a rod assembly as defined in claim 17, wherein the set curved configuration comprises a compound curve.

25. The method for installing a rod assembly as defined in claim 24, wherein the curved configuration is disposed in more than one plane defined by a longitudinal axis of the flexible tubular body.
